(19) United States
(12) Patent Application Publication
(10) Pub. No.: US 2023/0417176 A1
(43) Pub. Date: Dec. 28, 2023

(54) BOOST REGULATOR FOR SUPERCHARGER BYPASS VALVE

(71) Applicant: Hamburger's Specialty Vehicles, Inc., Toms River, NJ (US)

(72) Inventors: David Goral, Bayville, NJ (US); Edward Hamburger, Toms River, NJ (US)

(73) Assignee: Hamburger's Specialty Vehicles, Inc., Toms River, NJ (US)

(21) Appl. No.: 18/214,813

(22) Filed: Jun. 27, 2023

Related U.S. Application Data
(60) Provisional application No. 63/355,753, filed on Jun. 27, 2022.

(51) Int. Cl. F02B 37/22

(52) U.S. Cl. CPC F02B 37/225

(57) ABSTRACT

A boost regulator for a supercharger is responsive to one or more vehicle operation parameter inputs to determine limits of boost applied to an internal combustion engine. In one configuration, the boost regulator limits the amount of movement of a conventional dashpot boost control valve actuator based on various vehicle and sensor input data. In another configuration, the boost regulator adjusts the amount of boost output during supercharger operation in response to the vehicle and sensor input data.

### CROSS-REFERENCE TO RELATED APPLICATIONS

This application claims the benefit of U.S. Provisional Application No. 63/355,753, filed Jun. 27, 2022, the disclosure of which is incorporated herein by reference in its entirety.

### BACKGROUND OF THE INVENTION

This invention relates in general to boosted intake internal combustion engines and supercharger bypass control mechanisms. In particular, this invention relates to electronically controlled, variable position backstops to regulate an output pressure bypass state of a supercharger.

Superchargers are well known in the art as a means to increase output power of an internal combustion engine. These devices increase the volume of air/fuel mixture admitted into an engine in order to generate additional power from the larger charge admitted into the combustion chamber. Roots-type and screw-type superchargers are known in the art and often utilize a vacuum actuated bypass to regulate the amount of boost admitted based on engine operating conditions. In certain instances, centrifugal style superchargers also utilize a similar vacuum bypass actuator. It is well known that these types of superchargers are mechanically coupled to the engine and spin at a speed proportional to the engine speed. In operation, superchargers force more air into the engine than could normally be aspirated without the addition of the supercharger. However, maximum engine performance is not always desired for every operating condition. A constantly running supercharger produces ill effects when maximum power output is not utilized or required. In particular, increased pressure on engine components produces excessive wear and reduced drivability at part-load operating levels. Manufacturers of supercharger kits utilize methods to selectively bypass or re-circulate the forced air back to the compressor inlet or vent it to the atmosphere. This bypassing or recirculation minimizes any negative effects when maximum performance is not needed, but certain operating conditions can cause drivability issues. In addition, maximum boost is not always desired, but currently there is no way to provide “partial” boost reliability with a vacuum actuated bypass valve.

Roots or screw type supercharger are positive displacement superchargers that pump a fixed volume of air into the engine every revolution. The pressure or boost curve of these units is relatively flat, meaning that regardless of engine RPM boost remains relatively constant. When the supercharger is “activated” by the bypass value closing, there is an abrupt or violent transition from no boost to full boost, regardless of engine RPM. The more boost the supercharger makes, the more violent this transition from the “off” or non-boosted state to the “on” or boosted state.

Regardless of supercharger design, a typical vacuum actuated bypass valve can effectively only maintain two states, either open or closed. The valve is constructed with a spring biasing the supercharger operating state to either an open or closed state at rest. The valve actuation is controlled solely by the intake manifold vacuum/pressure. One drawback to these vacuum actuated valves is that their operation is fairly unstable ‘in-between’ opening and closing. It is difficult to hold the valve steady at a fixed position in an intermediary state during normal driving. The exact opening and closing pressures vary between applications, but typically the valve closes at an absolute manifold pressure in the range of 75-95 kpa.

Regardless of supercharger type, drivability issues are even more apparent if a vehicle is up-fitted with an aftermarket camshaft (high lift, high overlap cam lobe profile) that reduces the engine's ability to create vacuum. There are many aftermarket camshafts that increase the manifold pressure (reduce the engine's ability to create vacuum) to 75-85 kpa during cruising conditions. These camshaft configurations tend to force the Existing bypass valve open and closed almost the entire time during the driving cycle. This greatly reduces the drivability of the vehicle as the vehicle constantly fluctuates between a boosted and non-boosted state as the bypass valve is controlled only by manifold vacuum.

Other attempts to address drivability issues by regulating boost levels focus on shifting bias strategies of the vacuum valve. For example, U.S. Pat. No. 8,046,997 to Bell et al., shifts the bias of the valve from a normally closed state to a normally open state. Rather than using engine manifold vacuum to open the bypass valve, as is the typical configuration, the Bell device uses the boost created from the supercharger to initiate the bypass valve closing event. This valve closing event is initiated at a boost pressure of approximately 7 kPa over atmospheric, and fully closes the valve at approximately 42 kPa over atmospheric. This solution tends to be extremely limited, and applicable mainly to applications where a screw-type supercharger creates boost pressures well in excess of 42 kPa for a majority of the time in order to be efficient. This solution does not allow the flexibility of opening and closing the existing bypass valve at varying times. The Bell device control is fixed mechanically based on the springs used in the valve, and its operation is solely based on manifold pressure.

Thus, it would be desirable to regulate the boost level of a supercharger with greater precision and regard to specific driving conditions or demands.

### SUMMARY OF THE INVENTION

This invention relates in general to boosted intake internal combustion engines and supercharger bypass control mechanisms. In particular, this invention relates to electronically controlled, variable position backstops to regulate an output pressure bypass state of a supercharger. This invention improves drivability of a vehicle equipped with a supercharger (typically aftermarket) utilizing a vacuum actuated bypass (a.k.a recirculation, anti-surge) valve by limiting or actively regulating the boost delivered to the engine based on one or more vehicle inputs. In certain embodiments, the invention achieves this improvement by limiting the effectively closed position of the bypass valve or boost control valve. In other embodiments, the invention regulates boost control by using an actuator assembly to position the boost control valve or bypass valve in a desired flow condition based on the one or more vehicle inputs. This invention can be used in roots and screw type superchargers that utilize a vacuum actuated bypass, but can also be utilized in centrifugal style superchargers with a similar vacuum bypass actuator.

In one embodiment, the invention is configured as an electronically controlled, variable position stop that effectively limits the fully closed position of an existing vacuum/pressure actuated bypass valve in an aftermarket supercharger. It utilizes a microcontroller to read data from the vehicle, interprets the signals, and controls an actuator to adjust a stop that will not allow the existing bypass valve to close all the way. The device does not affect the existing vacuum actuators normal operating state, but the effective “closed” position is limited externally utilizing the inventive backstop device and software control protocol. This results in being able to clip the boost that is delivered to the engine which can be precisely and variably controlled by the accelerator pedal position and/or other variables available.

In another embodiment, the invention is configured as a boost regulator that replaces an existing vacuum/pressure actuated bypass valve with an electronically controlled and actuated bypass valve system. The boost regulator uses a motor, and may include an associated geartrain, to position the bypass valve in a desired flow position, such as fully open, partially open, or fully closed, to regulate the supercharger boost condition.

As one illustrative example of the benefits of the inventive backstop control, a track vehicle can be outfitted with an aftermarket positive displacement supercharger that outputs 12 lbs. of boost throughout the RPM band. With a typical vacuum actuated bypass valve, there is no reliable way of limiting boost to 7 lbs. of boost at 50% accelerator pedal position (APP), and 10 lbs. of boost at 75% APP, and also to allow full boost at 100% APP. The backstop device allows a boost control profile to adjust the effective closed position of the existing bypass valve. Alternatively, the boost regulator embodiment permits control of the effective closed position of the boost control valve directly by controlling the actuator position. The profile provides a more linear power curve based on accelerator pedal position than can be provided by a typical “drive by cable” naturally aspirated engine.

In another illustrative example, in straight line, full power acceleration events (a.k.a. drag racing). it may be desirable to limit supercharger boost in a first gear launch scenario to limit wheel slip and maximize power transfer to the pavement. The backstop and control protocol enables a boost control profile to be tailored to specific boost ranges for different RPM ranges and/or transmission gear positions. For this example, one such protocol may be configured to limit boost to 7 lbs. in first gear under 4000 rpm and gradually increase boost to a maximum from 4000 RPM to an upper RPM level such as engine redline. The system may further be configured to provide maximum boost in all of the other gears. In other protocols, certain operating configurations may have boost truncated or completely bypassed in certain transmission gear modes. In one aspect, the backstop may be actuated to maintain the bypass valve in the wide open position, or alternatively in other partially opened positions to limit boost in overdrive gear ranges. Such an operational protocol can prevent damage to gear trains, such as overdrive gears that are not capable of handling boosted power output. Other custom boost limiting profiles can be created using a variety of existing vehicle sensors.

In one embodiment of the invention, a closed-loop controlled DC motor is remotely mounted from the existing bypass valve. The motor actuates a cable connected to the variable stop. The backstop pivots independently on the existing shaft that controls the internal butterfly valve of the bypass. The backstop includes one or more intermediate steps or positions that limits the closing of the valve by restricting movement of the existing bracket on the end of the shaft. Alternatively, the backstop may be mounted to pivot on a different pivot axis.

In yet another embodiment of the invention, the backstop may be configured as a variable movement plunger, connected to either the diaphragm of the actuation valve or mounted to the intake, supercharger, or other mounting surface and actuate against a stop of the pivot associated with operation of the butterfly valve. This configuration can effectively limit the linear motion of the plunger or the diaphragm. Further, another actuation mechanism may utilize a worm gear/shaft type setup where the variable position stop is part of, or attached to, a worm gear that rotates the stop. These alternative variable stops can be actuated directly, or indirectly via any type of motor or solenoid to control the valve position. This includes, but is not limited to, DC motors, AC motors, stepper motors, and servo motors, along with pneumatic or hydraulic actuators and motors.

In yet another embodiment, the boost regulator is configured to replace the dashpot actuator and utilize the above-referenced motor controls to directly control actuator position to tailor boost output to specific driving conditions, regardless of manifold absolute pressure values.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a perspective view of a first embodiment supercharger boost control assembly in accordance with the invention.

FIG. 2 is an enlarged, perspective view of an boost regulator and boost control valve of the supercharger boost control assembly of FIG. 1.

FIG. 3 is a perspective view of the boost regulator and boost control valve of FIG. 2 showing an embodiment of an actuation gear train.

FIG. 4 is another perspective view of the boost regulator and boost control valve of FIG. 2.

FIG. 5 is a perspective view of the boost regulator and boost control valve of FIG. 3 showing a portion of the actuation gear train.

FIG. 6 is an exploded view of the boost regulator and boost control valve of FIG. 2.

FIG. 7 is an assembly view of a supercharger boost control assembly and a supercharger.

FIG. 8 is an enlarged, elevational view of a second embodiment of a variable position backstop and boost control dashpot of a supercharger boost control assembly in accordance with the invention.

FIG. 9 is an enlarged, schematic view of the variable position backstop showing relative actuation forces and component movements.

FIG. 10 is an elevational view of the supercharger boost control assembly of FIG. 8 mounted to a supercharger and having the variable position backstop in a partial boost stop position.

FIG. 11 is an elevational view of the supercharger boost control assembly of FIG. 10 having the variable position backstop in a partial boost stop position and a boost actuator dashpot without engine vacuum.

FIG. 12 is an elevational view of the supercharger boost control assembly of FIG. 11 having the variable position backstop in a partial boost stop position and a boost actuator dashpot with engine vacuum.

FIG. 13 is an elevational view of the supercharger boost control assembly of FIG. 8 having the variable position backstop in a maximum boost stop position and a boost actuator dashpot without engine vacuum.

FIG. 14 is an elevational view of the supercharger boost control assembly of FIG. 8 having the variable position backstop in a minimum boost stop position and a boost actuator dashpot without engine vacuum.

### DETAILED DESCRIPTION OF THE PREFERRED EMBODIMENT

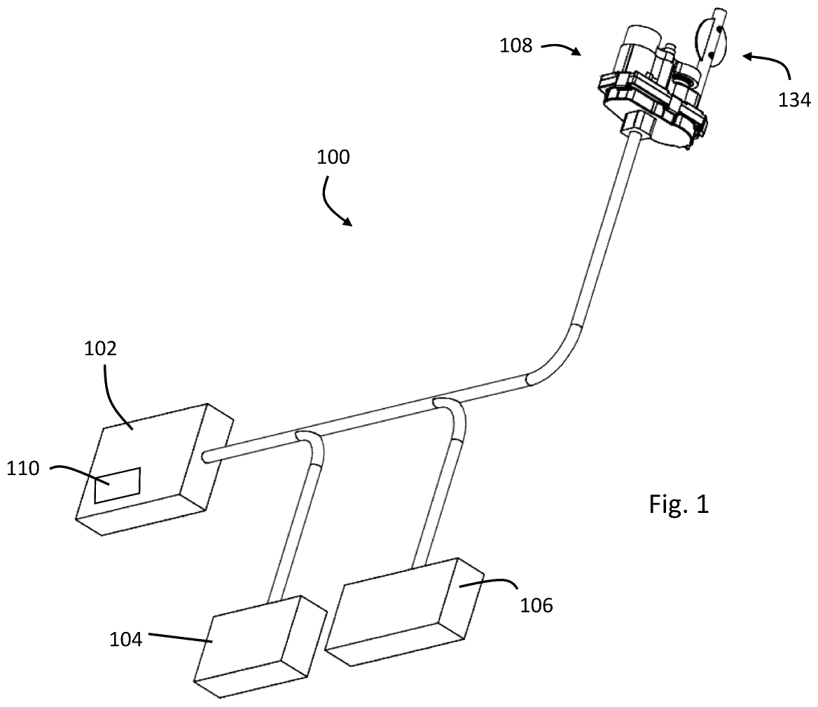

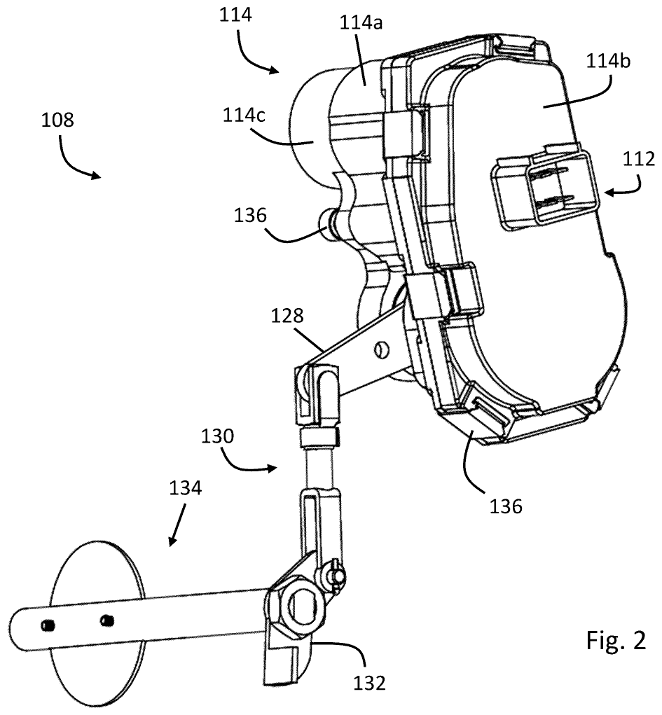

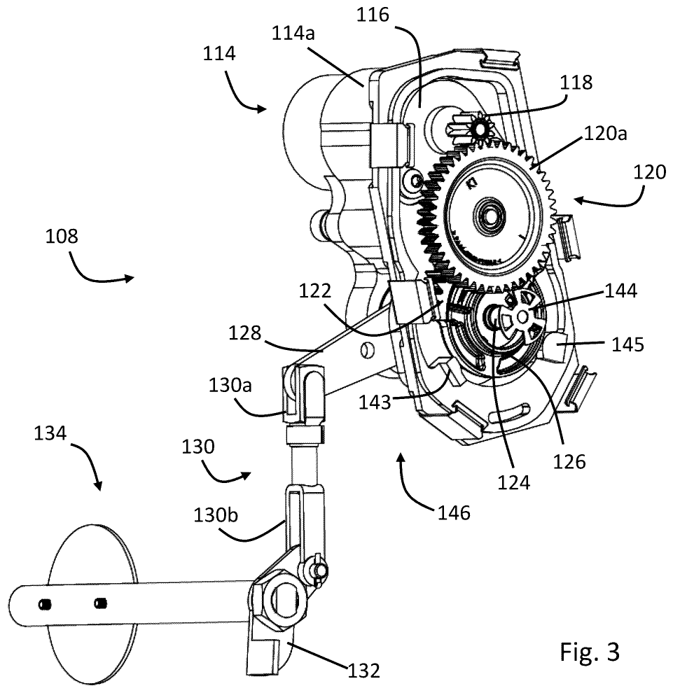

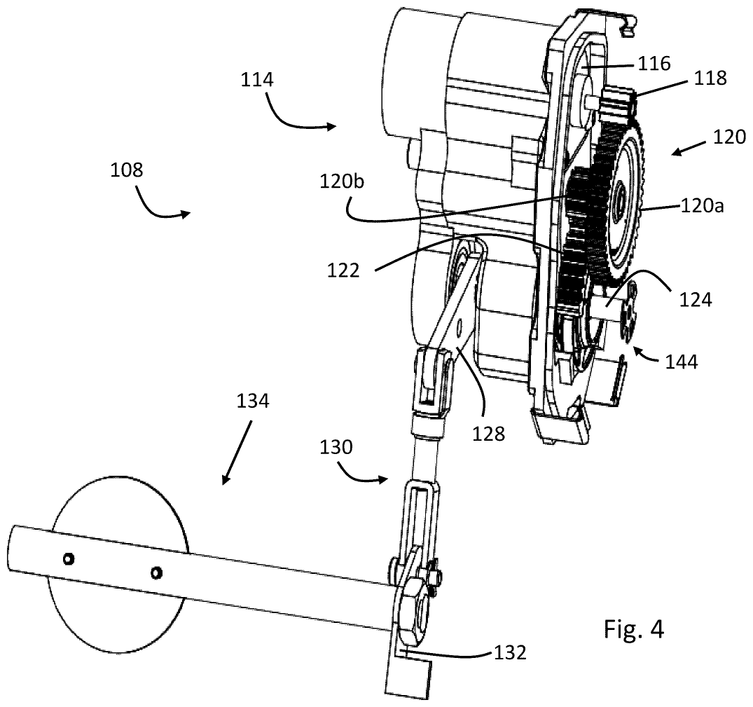

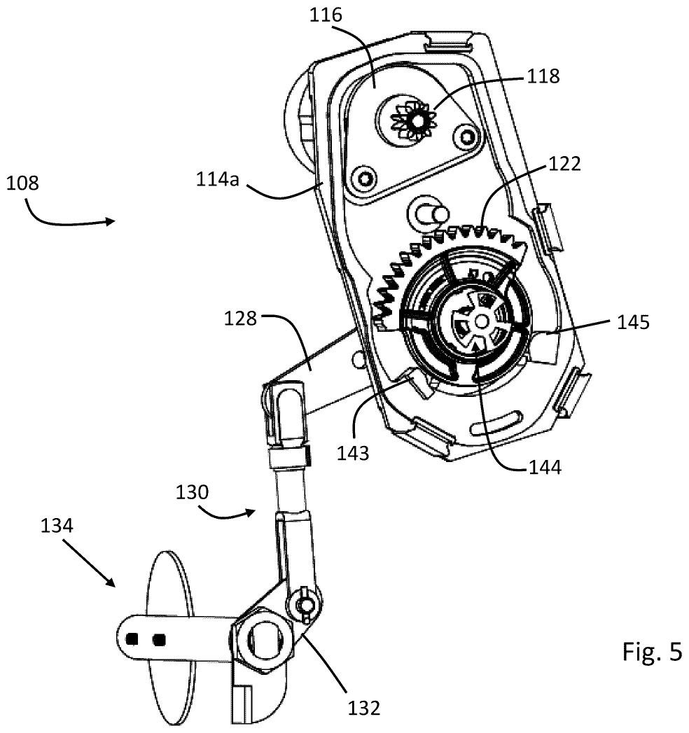

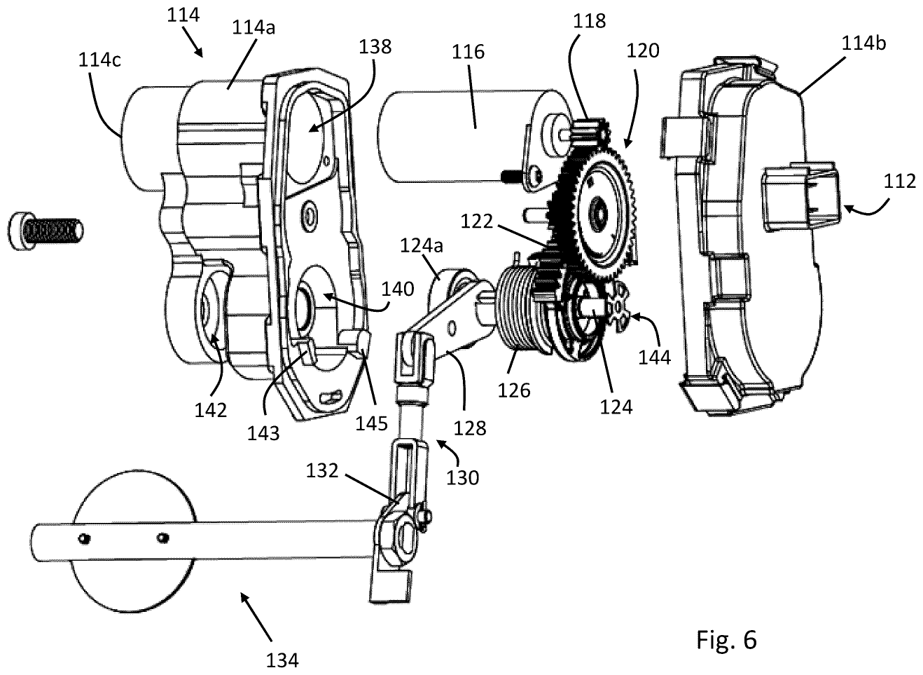

Referring now to the drawings, there is illustrated in FIGS. 1-6 a first embodiment supercharger boost control assembly, shown generally at 100. The supercharger boost control assembly 100 comprises a controller 102, one or more vehicle operation parameter inputs 104, a power input 106, and a boost regulator 108. The supercharger boost control assembly 100 can include any number of vehicle operation parameter inputs from dedicated sensors, existing on-board computer systems, from vehicle subsystems (such as coil or distributor outputs). The controller 102 can be any type of computer or microprocessor. Further, the vehicle operation parameter input can be any desired input including, but not limited to, engine RPM, accelerator pedal position, transmission gear position, manifold absolute pressure level, vehicle speed, vehicle acceleration, temperature, or other input signals from any vehicle sensors. The supercharger boost control assembly 100 includes a boost control profile 110, as part of the controller 102, to adjust the effective closed position of a boost control valve 134 based on data from at least one of the sources of the vehicle operation parameter input 104. The boost control valve 134 is illustrated as a butterfly valve mounted on a boost shaft, which is conventional in the art. A connector 112 couples the controller 102 in electrical communication with the boost regulator 108.

The boost control profile 110 is capable of receiving multiple data inputs indicative of different vehicle components and their related operational states to determine a desired position of the boost control valve 134. In one aspect of the invention, the supercharger boost control assembly 100 is capable of altering the boost, or supercharger output, delivered to the engine by utilizing a direct user input parameter, such as accelerator position, rather than only relying on a secondary or time-lagged signal such as manifold vacuum. The boost control profile 110 is configurable or programable to operate the boost regulator 108 based on data from multiple vehicle operation parameters which are indicative of a desired boost demand. In one example of a boost control profile, the boost regulator 108 is capable of adjusting the supercharger to provide about 7 pounds of boost at a 50% accelerator pedal position (APP), 10 pounds of boost at 75% APP, and allow full boost at 100% APP.

The boost regulator 108 includes a housing 114 having a support casing 114a, a front cover 114b, and a back cover 114c. While the connector 112 is illustrated as part of the front cover 114b, any part of the housing 114 may be a suitable location for the connector 112. The housing 114 may be formed from any material such as plastic, composite, or metal, and the front and rear covers 114b, 114c may be secured to the support casing 114a by retainers 136, such as clips, screws, or other fastener elements. In the illustrated embodiment, the functional elements of the boost regulator 108 are located relative to each other in the support casing 114a. A motor 116 includes a drive gear 118 that engages a first gear or driven portion 120a of a transmission gear 120. A second gear or driving portion 120b of the transmission gear 120 engages a sector gear 122. The motor 116 may be any type of motor such as, for example, a DC motor, closed-loop controlled DC motor, stepper motor, servo motor, or variable reluctance motor. The sector gear 122 rotates a shaft 124 that is connected to an actuator link 128. The shaft 124 may include a support bearing 124a. The actuator link 128 is moved between a first stop position and a second stop position. The actuator link 128 is biased into one of the first or second stop positions by a resilient element such as a spring 126. A position indicator 144, such as a potentiometer or encoder, is connected to the sector gear 122 or shaft 124 to indicate the position of the boost control valve 134 relative to an output bore of the supercharger. Collectively, the sector gear 122, shaft 124, spring 126, and actuator link 128 may form a boost actuator assembly 146.

A connecting linkage 130 transfers movement of the actuator link 128 to a boost valve arm 132 which moves the boost control valve 134 between a first boost control valve position and a second boost control valve position. In certain embodiments, the first boost valve control position may be a closed or no boost position and the second boost control valve position may be an opened position that includes any partially opened position defining a partial percentage of boost condition or a fully opened position defining a full boost condition. The connecting linkage 130 may be any linkage configured to move the boost valve arm 132 and/or the boost control valve 134. In the illustrated embodiment, the connecting linkage 130 is configured with a first clevis or yoke 130a connected to the actuator link 128 and a second clevis or yoke 130b connected to the boost valve arm 132. The connecting link 130 may also be adjustable lengthwise between the two devises.

In certain embodiments, the support casing 114a of the housing 114 defines a motor compartment 138 to accommodate motor 116, a spring compartment 140 to locate and secure spring 126, and a bearing compartment 142 to locate support bearing 124a. The support casing 114a may include bosses configured as a first stop 143 and a second stop 145 that limit rotational travel or define overall travel limits of the sector gear 122 and thus the boost control valve.

In operation, the controller 102 receives data from the one or more vehicle operation parameter inputs 104 related to driver inputs to vehicle (primary inputs) and/or operating conditions of the vehicle (secondary inputs). These operating conditions may include primary inputs such as accelerator position, gear selection, and/or clutch pedal position and secondary inputs such as vehicle acceleration, engine RPM, engine or powertrain torque, manifold absolute pressure level, mass air flow data, vehicle speed, vehicle acceleration, temperature, or other input signals from any vehicle sensors. The controller 102 further receives positional information regarding the boost control valve 134 from the position indicator 144. The controller 102 processes the vehicle operation parameter inputs 104 with the boost control profile 110 to determine the amount of actuation needed from the boost actuator assembly 146 to achieve the desired boost level from the supercharger. The controller then energizes the motor 116 to drive the sector gear 122, actuator link 128, and boost control valve 134 from a first boost control valve position to a second boost control valve position. In certain operating conditions where boost is desired, the first position may be a closed boost valve position and the second boost valve position may be a partially or fully opened boost valve position. In certain embodiments, the second stop position may be the fully opened boost valve position, and the controller determines an intermediate or third stop position related to a partial boost condition. The controller is configured to determine a potentially infinite number of intermediate boost condition positions in response to the vehicle operational parameter inputs and the boost control profile. In certain embodiments, the motor 116 drives in one direction and the resilient member 126 provides a return actuation force when the motor is deenergized. Alternatively, the motor 116 may be configured to drive in both directions and the resilient member 126 provides a failsafe, boost closed position should the motor 116 fail.

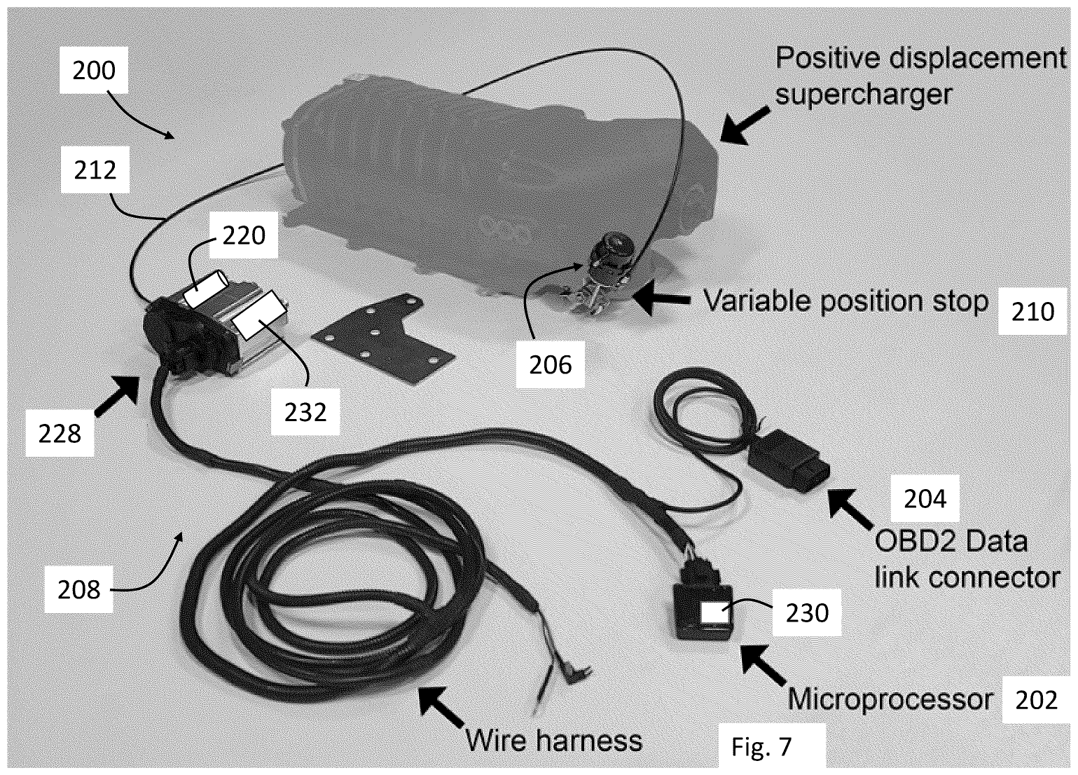

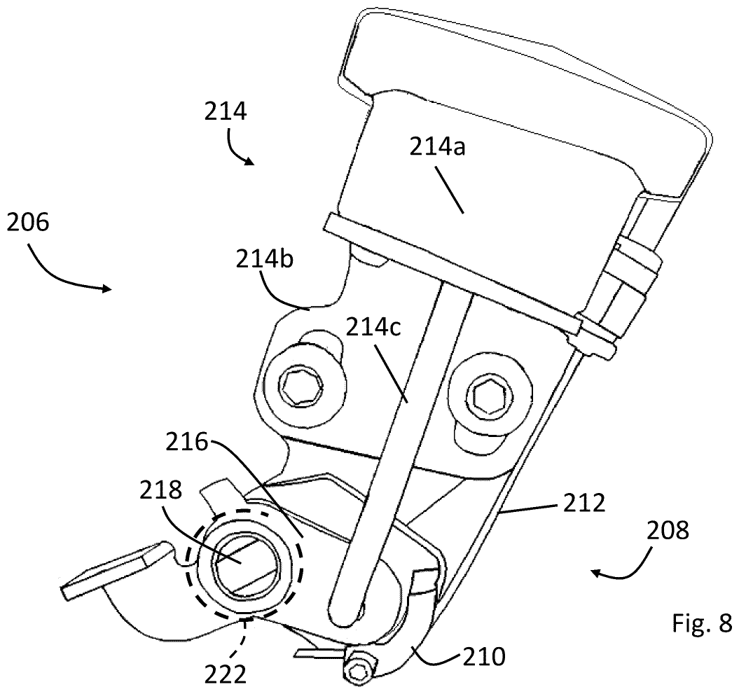

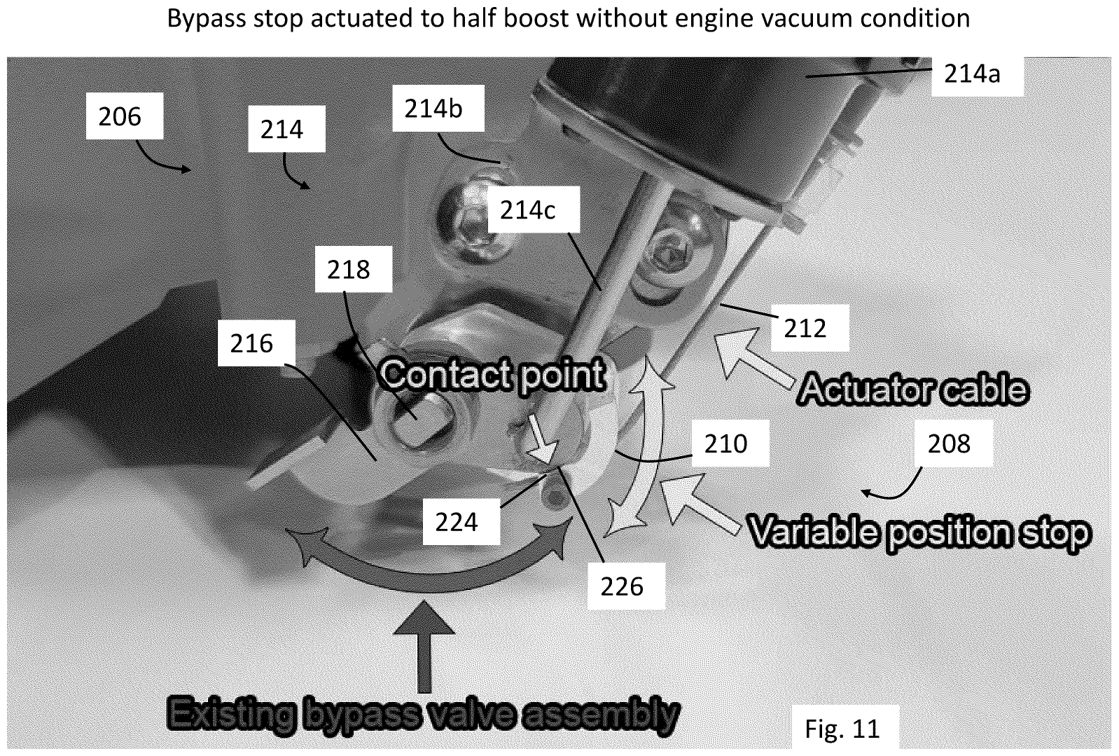

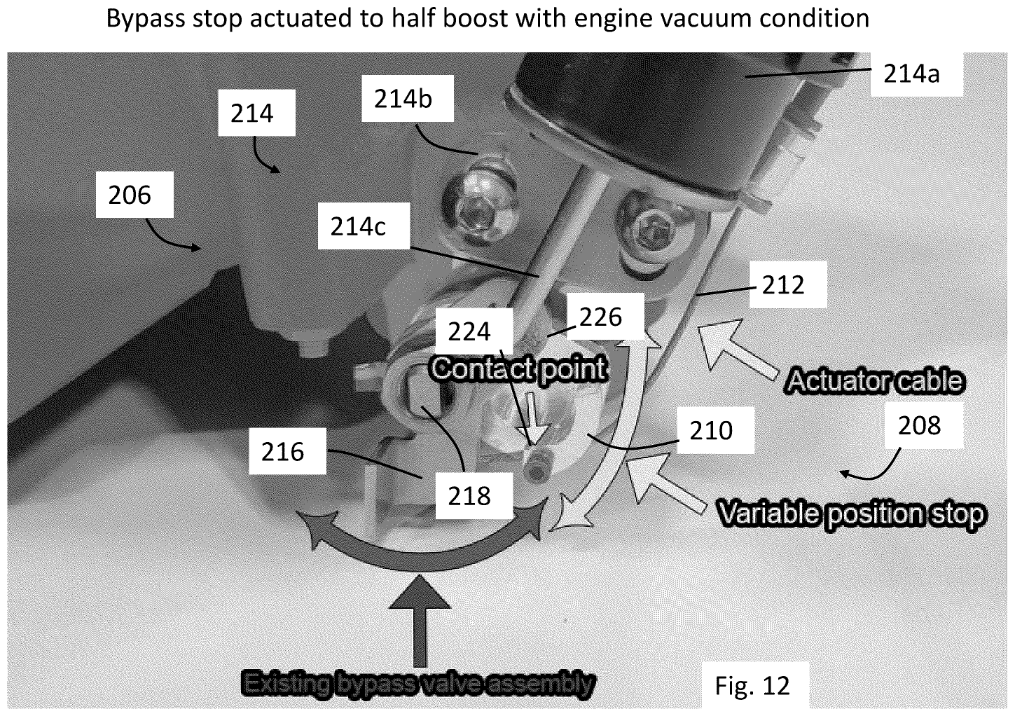

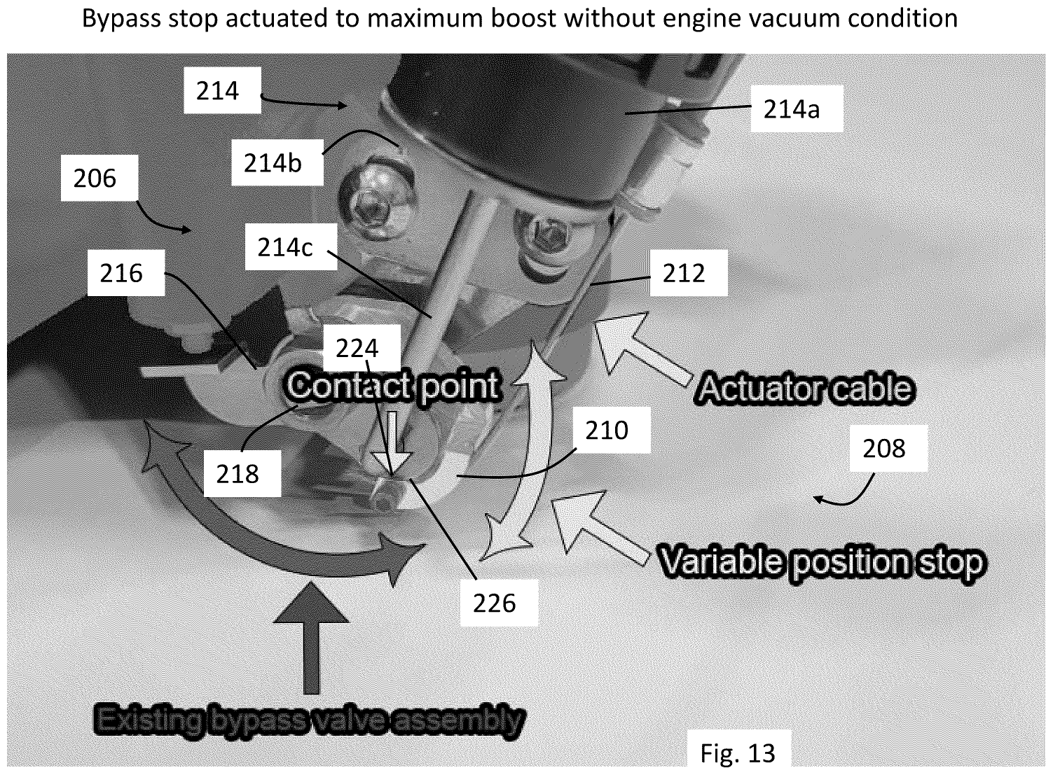

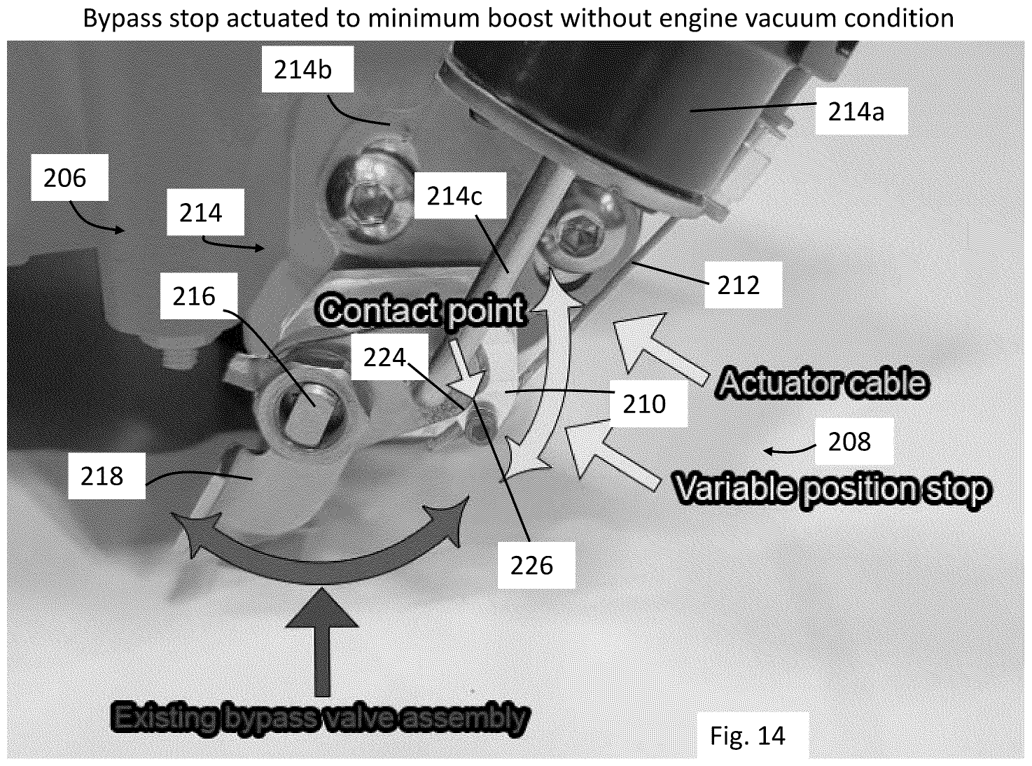

Referring now to the drawings, there is illustrated in FIGS. 7-14 a second embodiment of a supercharger boost control assembly, shown generally at 200. As shown in FIGS. 7 and 8, the supercharger boost control assembly 200 comprises a controller 202, a vehicle operation parameter input 204, a boost actuator assembly 206, and a boost regulator 208 that includes a variable position backstop 210 and a backstop actuator assembly 228 configured to move the variable position backstop 210 between an engaged position that at least partially limits supercharger boost and a disengaged position where full supercharger output can be provided. In certain embodiments, the backstop actuator assembly 228 may be remotely mounted to control movement of the variable position backstop 210 by way of a connecting linkage such as a Bowden cable 212. Alternatively, the backstop actuator assembly 228 can be configured as a worm drive, a stepper motor, a linear motor, or any other desired element to move the variable position backstop 210. The backstop actuator assembly, as described below, may further include a motor 220 and a The supercharger boost control assembly 200 can rely on any number of vehicle operation parameter inputs 204 such as vehicle data provided by an On Board Diagnostic protocol outputs (e.g., OBD2) or by inputs from individual sensors configured to measure and output data related to specific vehicle parameters or by connecting to certain vehicle subsystems. Examples of vehicle operation parameter inputs may include data such as engine RPM, throttle position, transmission gear selection, manifold absolute pressure, intake mass air flow, and other parameters. The controller 202 can be any type of computer or microprocessor configured to execute a boost control profile 230, as will be explained below.

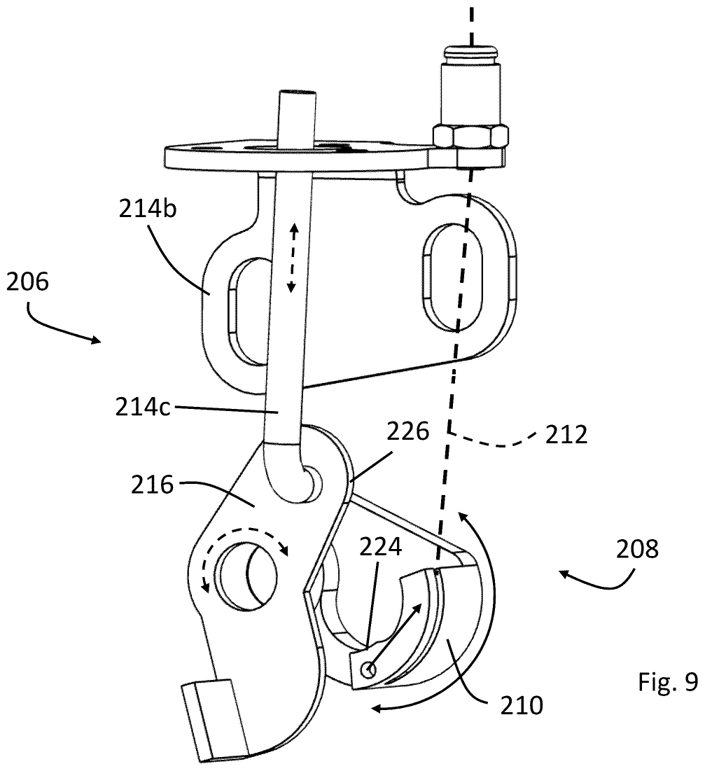

As shown in FIGS. 8 and 9, the boost actuator assembly 206 comprises a vacuum powered actuator or dashpot 214 that includes a vacuum diaphragm 214a, a mounting bracket 214b, and a dashpot actuation arm 214c. The dashpot 214 is generally conventional in the art. The actuation arm 214c of the dashpot 214 is connected to a boost valve arm 216 that operates a boost control valve 218, similar to boost control valve 132 described above. The vacuum diaphragm 214a of the dashpot 214 is connected to a vacuum source such as the intake manifold. In certain configurations, the intake manifold vacuum signal holds the bypass or boost control valve in an open position minimizing the output of the supercharger into the intake. As intake manifold vacuum decreases (such as when the accelerator pedal is rapidly depressed), a spring element associated with the dashpot 214 moves or rotates the boost control arm 216 toward a closed opposition to provide an increased output from the supercharger and divert less output away from the engine. As manifold pressure increases (such as when the accelerator pedal moves back toward an idle position) the boost control valve opens. The variable position backstop 210 is actuated to limit the amount of movement of the boost control arm 216 toward the closed position. The amount of variable backstop movement is based on certain vehicle operating parameter inputs 204 and the desired programming of the boost control profile 230 to improve drivability during partial or intermittent vacuum conditions where boost may be applied but not desired.

Referring again to FIG. 7, the boost regulator 208 includes a motor 220 that moves the variable position backstop 210. The motor 220 drives an actuation mechanism configured as a linkage drive 232 that draws the Bowden cable 212 to rotate the variable position backstop 210 in a first direction. A return spring 222 is shown mounted to the variable position backstop 210 and moves it to a second position that is opposite the first position. Alternatively, the return spring 222 may be part of the linkage drive 232. In certain embodiments, the second position is a rest or home position related to a no boost output condition.

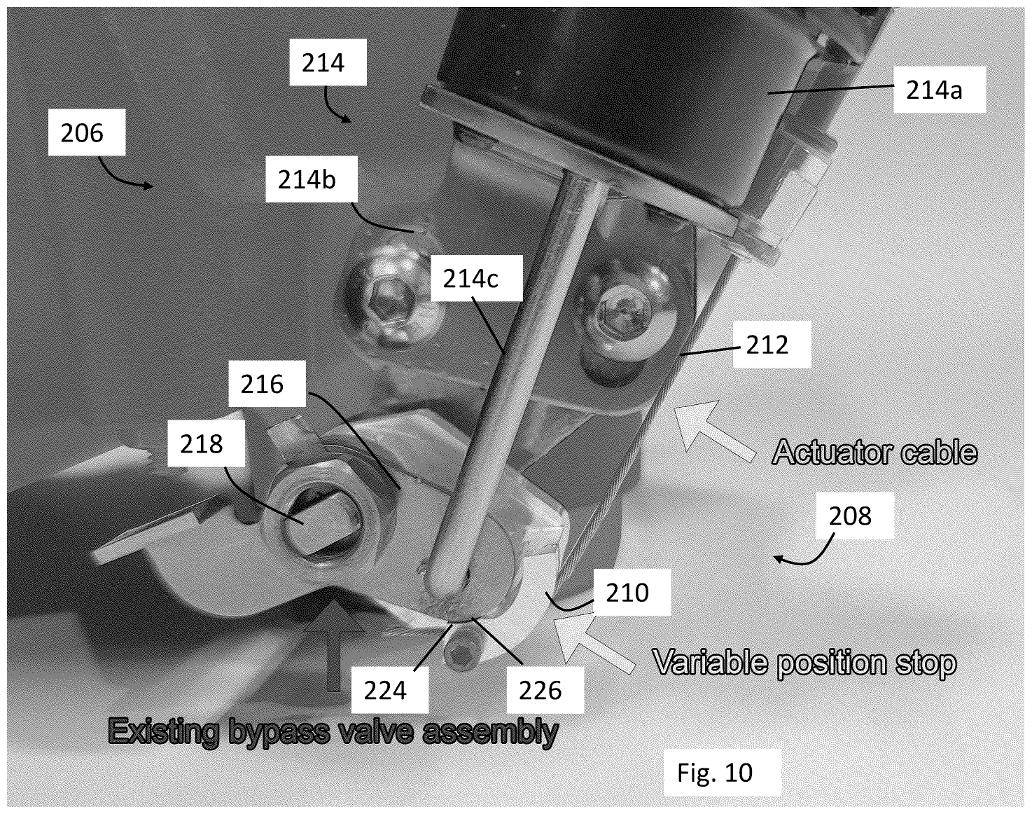

The variable position backstop 210 includes a seat 224 that locates against a contact surface 226 of the boost control arm 216 to limit the overall movement thereof. In FIGS. 10-14, as the variable position backstop 210 is moved relative to the boost control arm 216, the seat 224 is positioned against different portions of the contact surface 226 to vary the amount of boost control arm movement permitted. In operation, the controller 202 receives vehicle performance information from the vehicle operation parameter input 204. Based on the data received, the boost control profile 230 assesses whether or not there is a demand for supercharger boost. For engine operating conditions where the manifold vacuum level would apply boost but other operating data suggests that a boost condition does not exist, the boost regulator 208 moves the variable position backstop an amount sufficient to limit movement of the boost control arm 216.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A supercharger boost control assembly comprising:
a boost regulator configured to control the output of a supercharger, the boost regulator in communication with a boost control valve having a boost valve arm, the boost control valve defining a first stop position and the boost regulator configured to limit the boost control valve to a second stop position that is different from the first stop position; and
a controller having a boost control profile, the controller receiving an at least one vehicle operation input parameter to define the second stop position.

2. The supercharger boost control assembly of claim 1 wherein the boost regulator is configured to selectively move the boost control valve to the second stop position, the second stop position defining one of a partial boost output condition or a full boost output condition of the supercharger.

3. The supercharger boost control assembly of claim 2 wherein the controller defines an intermediate stop position based on the at least one vehicle operation input parameter being a primary input.

4. The supercharger boost control assembly of claim 3 wherein the primary input is one of a throttle position, a gear selection, or a clutch pedal position.

5. The supercharger boost control assembly of claim 4 wherein the controller is responsive a secondary input of vehicle acceleration, engine RPM, manifold absolute pressure level, mass air flow data, or vehicle speed.

6. The supercharger boost control assembly of claim 1 wherein the boost regulator includes an actuator assembly connected to the boost valve arm, the actuator assembly comprising a motor in electrical communication with the controller.

7. The supercharger boost control assembly of claim 6 wherein the actuator assembly is a boost actuator assembly comprising a sector gear, a spring, and an actuator link.

8. The supercharger boost control assembly of claim 7 wherein a transmission gear includes a driven gear engaged with the motor and a driving gear that engages the sector gear.

9. The supercharger boost control assembly of claim 1 wherein a position indicator communicates with the controller to provide a location of the boost control valve relative to the first stop position.

10. The supercharger boost control assembly of claim 1 wherein the first stop position defines a boost bypass condition such that output of the supercharger is bypassed and the second stop position is determined by at least one of a primary input and a secondary input.

11. The supercharger boost control assembly of claim 1 wherein the supercharger is one of a roots supercharger, a screw-type supercharger, or a centrifugal supercharger.

12. The supercharger boost control assembly of claim 1 wherein the boost regulator is a variable position backstop and a boost actuator assembly configured to move the boost control valve toward a full boost output condition of the supercharger.

13. The supercharger boost control assembly of claim 12 wherein the boost actuator assembly is responsive to a manifold absolute pressure and the boost regulator moves the variable position backstop to the second position in response to the controller.

14. The supercharger boost control assembly of claim 12 wherein the backstop actuator is one of a Bowden cable, a worm drive, a stepper motor, or a linear motor.

15. The supercharger boost control assembly of claim 12 wherein the variable position backstop defines at least one locating contour configured to engage a portion of the boost valve arm to limit movement of the boost control valve from the first stop position to the second stop position.

16. A supercharger boost control assembly comprising:
a vacuum powered, boost control dashpot coupled to a boost valve arm that communicates with a boost control valve, the boost control valve defining a first stop position; and
a variable position backstop configured to be selectively oriented relative to the boost valve arm to define a second stop position that is different from the first stop position.

17. The supercharger boost control assembly of claim 16 wherein the variable position backstop is coupled to a backstop actuator assembly, a controller receiving at least one vehicle operating parameter input and operating the backstop actuator assembly to articulate the variable position backstop to contact the boost valve arm at a contact surface defining the second stop position.

18. The supercharger boost control assembly of claim 16 wherein the variable position backstop defines at least one locating contour configured to engage a portion of the boost valve arm to limit movement of the boost control valve toward the second stop position.

19. A supercharger boost control assembly comprising:
a boost regulator configured to control the output of a supercharger, the boost regulator in communication with a boost control valve having a boost valve arm, the boost control valve defining a first stop position defining a no boost output condition of the supercharger and the boost regulator configured to selectively move the boost control valve to a second stop position defining one of a partial boost output condition or a full boost output condition of the supercharger; and
a controller having a boost control profile, the controller receiving an at least one vehicle operation input parameter to define the second stop position.

20. The supercharger boost control assembly of claim 19 wherein the boost regulator includes an actuator assembly connected to the boost valve arm, the actuator assembly comprising a motor in electrical communication with the controller; and
a position indicator communicates with the controller to provide a location of the boost control valve relative to the first stop position.
